(19) United States
(12) Patent Application Publication
(10) Pub. No.: US 2022/0138598 A1
(43) Pub. Date: May 5, 2022

(54) REDUCING COMPUTATIONAL OVERHEAD INVOLVED WITH PROCESSING RECEIVED SERVICE REQUESTS

(71) Applicant: International Business Machines Corporation, Armonk, NY (US)

(72) Inventors: Sunhwan Lee, Menlo Park, CA (US); Pawan Chowdhary, San Jose, CA (US)

(21) Appl. No.: 17/088,340

(22) Filed: Nov. 3, 2020

(51) Int. Cl. G06N 5/04; G06K 9/62; G06N 3/04; G06Q 30/02

(52) U.S. Cl. CPC G06N 5/04; G06K 9/6256; G06Q 30/0206; G06Q 30/0204; G06N 3/04

(57) ABSTRACT

A computer-implemented method, according to one approach, is for reducing the computational overhead involved with processing received service requests. The computer-implemented method includes: collecting datasets, each dataset including: a previously submitted service request, and a team that satisfied the respective previously submitted service request. Features are also extracted from the datasets, and a model is trained using the features that are extracted from the datasets. Moreover, a newly submitted service request is received, and features are extracted from the newly submitted service request. A dataset that most closely matches the newly submitted service request is further determined by applying the model to the features extracted from the newly submitted service request.

### BACKGROUND

The present invention relates to service requests, and more specifically, this invention relates to reducing computational overhead involved with processing newly received service requests.

Service providers, such as information technology service providers, compete to secure highly valued service contracts. These service contracts typically correspond to service requests (e.g., requests for proposals) that are issued by potential customers who are in need of various services. Service providers typically compose multiple offers having different combinations of services, one or more of which are then submitted to the potential customer in an effort to secure the corresponding service contract.

Various aspects associated with different service requests and/or service offers are not standardized and therefore may vary greatly depending on the particular situation. As a result, conventional implementations have experienced significant variation in terms of the success they are able to achieve when analyzing and responding to service requests that are received. In an attempt to improve performance, some conventional implementations have relied on benchmark service information which essentially serves as a baseline to determine relevant service information. However, these benchmarks rarely resemble the specific details of actual service requests that are received from potential customers, e.g., such as offer types, delivery locations, customer geographies, customer industry type, configurations, etc.

In an attempt to gain a more accurate understanding of these benchmarks, service providers have been forced to rely on the expertise of their employees and the information they have retained from previously completed service deals. While this insight may provide some additional information that can be used to supplement benchmark service information, it is susceptible to human error and workplace attrition. Hence, service providers are often unable to compose offers that accurately forecast the various details that are associated with satisfying the service request. In some instances, 3^{rd} party vendors offer data that may also be used to supplement the benchmark service information, but it is highly undesirable for a service provider to purchase up-to-date supplemental data for all details associated with all services regularly from these 3^{rd} party vendors. As a result, service providers have conventionally been unable to compose offers which accurately address a given service request, much less efficiently.

### SUMMARY

A computer-implemented method, according to one approach, is for reducing the computational overhead involved with processing received service requests. The computer-implemented method includes: collecting datasets, each dataset including: a previously submitted service request, and a team that satisfied the respective previously submitted service request. Features are also extracted from the datasets, and a model is trained using the features that are extracted from the datasets. Moreover, a newly submitted service request is received, and features are extracted from the newly submitted service request. A dataset that most closely matches the newly submitted service request is further determined by applying the model to the features extracted from the newly submitted service request.

Thus, by identifying a previously satisfied service request, some of the approaches included herein are able to recommend a way of satisfying the service request that is known to produce favorable results. This is desirable, particularly in view of the conventional shortcomings that have been experienced, because by comparing certain features included in a new service request with the same certain features in various previously satisfied service requests, some of the approaches herein are able to significantly reduce the computational processing involved with producing a response (e.g., offer) to the new service request. The sheer number of different possible combinations of features from various previously satisfied service requests that may happen to correspond to the features presented in a newly received service request also extends far beyond what is humanly capable. In other words, the countless different combinations of features that may be relevant to a given service request is otherwise unprocessable by the unaided human mind.

For instance, in some approaches, training the model using the features extracted from the datasets includes: creating an embedding vector for each of at least some of the features extracted from the datasets, as well as inputting the embedding vectors and the datasets into a hidden layer. An iterative process is also performed which includes: selecting one of the datasets in the hidden layer to act as a target, identifying one of the remaining datasets in the hidden layer as a closest match to the acting target, and comparing the features of the acting target and the features of the identified one of the remaining datasets.

In other approaches, determining the dataset that most closely matches the newly submitted service request, by applying the model to the features extracted from the newly submitted service request includes: calculating a similarity score between the newly submitted service request and each of the datasets, and selecting the dataset that produced the highest similarity score as the dataset that most closely matches the newly submitted service request. As a result, determining a dataset that most closely matches the newly submitted service request by applying the model to the features extracted from the newly submitted service request reduces computational overhead of the computer.

Thus, the approaches herein provide significant improvements to conventional implementations that rely on the expertise of their employees and the information they have retained from previously completed service deals. Further still, these approaches are able to significantly accelerate the processing of newly received service requests, while also maintaining a high level of accuracy in terms of how the service request is ultimately satisfied. Thus, various ones of the approaches herein are also able to achieve substantial improvements over conventional systems that rely on quote-to-cash implementations and similar types of management analysis, e.g., as will be described in further detail below.

A computer program product, according to another approach, is for reducing the computational overhead involved with processing received service requests. The computer program product includes a computer readable storage medium having program instructions embodied therewith. Moreover, the program instructions are readable and/or executable by a processor to cause the processor to: perform the foregoing method.

A system, according to yet another approach, includes: a processor, and logic integrated with the processor, executable by the processor, or integrated with and executable by the processor. The logic is configured to: perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one approach.

FIG. 2 is a diagram of a representative hardware environment that may be associated with the servers and/or clients of FIG. 1, in accordance with one approach.

FIG. 3 is a diagram of a tiered data storage system, in accordance with one approach.

FIG. 4 is a partial representational view of a system, in accordance with one approach.

FIG. 5A is a flowchart of a method, in accordance with one approach.

FIG. 5B is a flowchart of sub-processes for one of the operations in the method of FIG. 5A, in accordance with one approach.

FIG. 6 is a partial representational view of a softmax model, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for processing newly received service requests. This is achieved by developing, training, and implementing a model capable of accurately and efficiently analyzing received service requests, e.g., as will be described in further detail below.

In one general approach, a computer-implemented method is for reducing the computational overhead involved with processing received service requests. The computer-implemented method includes: collecting datasets, each dataset including: a previously submitted service request, and a team that satisfied the respective previously submitted service request. Features are also extracted from the datasets, and a model is trained using the features that are extracted from the datasets. Moreover, a newly submitted service request is received, and features are extracted from the newly submitted service request. A dataset that most closely matches the newly submitted service request is further determined by applying the model to the features extracted from the newly submitted service request.

In another general approach, a computer program product is for reducing the computational overhead involved with processing received service requests. The computer program product includes a computer readable storage medium having program instructions embodied therewith. Moreover, the program instructions are readable and/or executable by a processor to cause the processor to: perform the foregoing method.

In yet another general approach, a system includes: a processor, and logic integrated with the processor, executable by the processor, or integrated with and executable by the processor. The logic is configured to: perform the foregoing method.

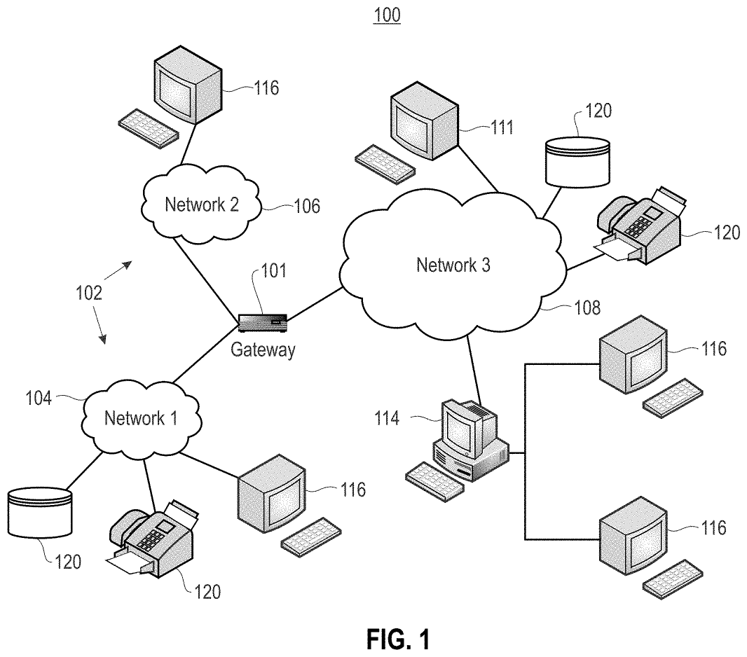

FIG. 1 illustrates an architecture 100, in accordance with one approach. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to, a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one approach.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment, a UNIX® system which virtually hosts a Microsoft® Windows® environment, a Microsoft® Windows® system which emulates an IBM® z/OS® environment, etc. This virtualization and/or emulation may be enhanced through the use of VMware® software, in some approaches.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

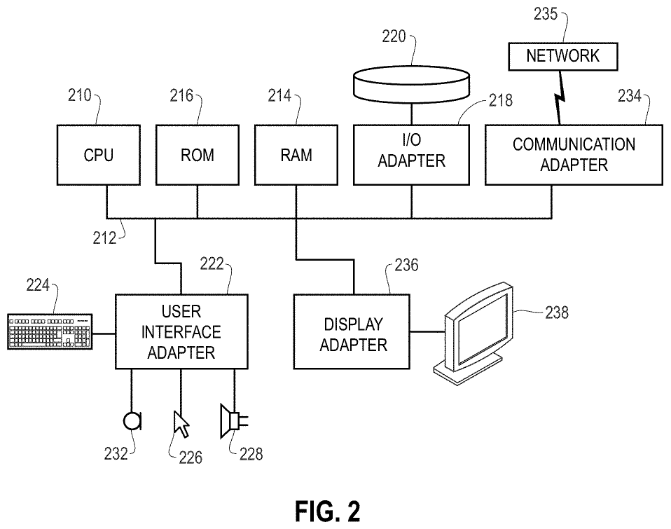

FIG. 2 shows a representative hardware environment associated with a user device 116 and/or server 114 of FIG. 1, in accordance with one approach. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred approach may also be implemented on platforms and operating systems other than those mentioned. A preferred approach may be written using eXtensible Markup Language (XML), C, and/or C++ language, or other programming languages, along with an object oriented programming methodology. Object oriented programming (OOP), which has become increasingly used to develop complex applications, may be used.

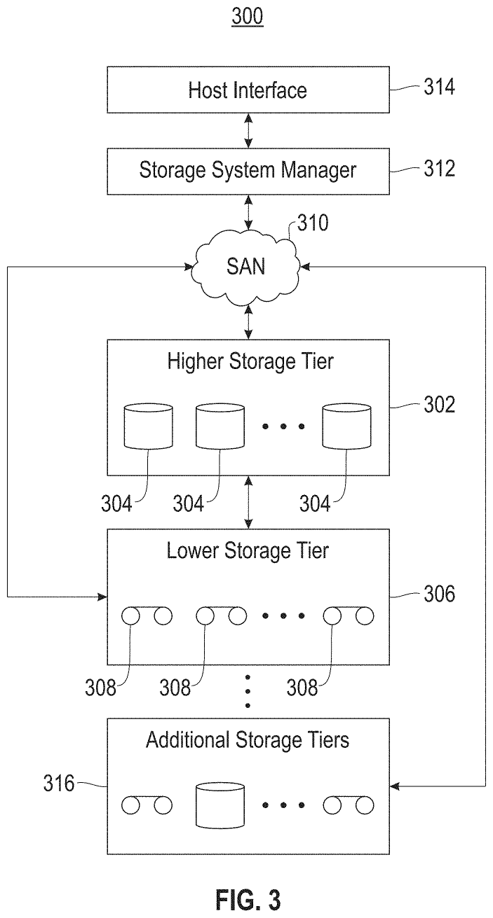

Now referring to FIG. 3, a storage system 300 is shown according to one approach. Note that some of the elements shown in FIG. 3 may be implemented as hardware and/or software, according to various approaches. The storage system 300 may include a storage system manager 312 for communicating with a plurality of media and/or drives on at least one higher storage tier 302 and at least one lower storage tier 306. The higher storage tier(s) 302 preferably may include one or more random access and/or direct access media 304, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 306 may preferably include one or more lower performing storage media 308, including sequential access media such as magnetic tape in tape drives and/or optical media, slower accessing HDDs, slower accessing SSDs, etc., and/or others noted herein or known in the art. One or more additional storage tiers 316 may include any combination of storage memory media as desired by a designer of the system 300. Also, any of the higher storage tiers 302 and/or the lower storage tiers 306 may include some combination of storage devices and/or storage media.

The storage system manager 312 may communicate with the drives and/or storage media 304, 308 on the higher storage tier(s) 302 and lower storage tier(s) 306 through a network 310, such as a storage area network (SAN), as shown in FIG. 3, or some other suitable network type. The storage system manager 312 may also communicate with one or more host systems (not shown) through a host interface 314, which may or may not be a part of the storage system manager 312. The storage system manager 312 and/or any other component of the storage system 300 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more approaches, the storage system 300 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 302 may include a majority of SSD storage media for storing data in a higher performing storage environment, and remaining storage tiers, including lower storage tier 306 and additional storage tiers 316, may include any combination of SSDs, HDDs, tape drives, etc. for storing data in a lower performing storage environment. In this way, more frequently accessed data, data having a higher priority, data that are to be accessed more quickly, etc., may be stored to the higher storage tier 302, while data not having one of these attributes may be stored to the additional storage tiers 316, including lower storage tier 306. Of course, one of skill in the art, upon reading the present descriptions, may devise many other combinations of storage media types to implement into different storage schemes, according to the approaches presented herein.

According to some approaches, the storage system (such as 300) may include logic configured to receive a request to open a data set, logic configured to determine if the requested data set is stored to a lower storage tier 306 of a tiered data storage system 300 in multiple associated portions, logic configured to move each associated portion of the requested data set to a higher storage tier 302 of the tiered data storage system 300, and logic configured to assemble the requested data set on the higher storage tier 302 of the tiered data storage system 300 from the associated portions.

Of course, this logic may be implemented as a method on any device and/or system or as a computer program product, according to various approaches.

As previously mentioned, service providers compete to secure highly valued service contracts which correspond to service requests issued by potential customers. However, various aspects associated with different service requests and/or service offers are not standardized and therefore may vary greatly depending on the particular situation. This has resulted in conventional implementations experiencing significant variation in terms of the success they are able to achieve when analyzing and responding to service requests that are received.

In an attempt to improve performance, some conventional implementations have relied on benchmark service information which essentially serves as a baseline to determine relevant service information. However, these benchmarks rarely resemble the specific details of actual service requests that are received from potential customers, e.g., such as offer types, delivery locations, customer geographies, customer industry type, configurations, etc.

In an attempt to gain a more accurate understanding of these benchmarks, service providers have been forced to rely on the expertise of their employees and the information they have retained from previously completed service deals. While this insight may provide some additional information that can be used to supplement benchmark service information, it is susceptible to human error and workplace attrition. Hence, service providers are often unable to compose offers that accurately forecast the various details that are associated with satisfying the service request.

In some instances, 3^{rd} party vendors offer data that may also be used to supplement the benchmark service information, but it is highly undesirable for a service provider to purchase up-to-date supplemental data for all details associated with all services regularly from these 3^{rd} party vendors. Additionally, this 3^{rd} party vendor offered data is often incomplete. For example, market benchmark data offered by 3^{rd} party vendors typically has missing information which significantly reduces the accuracy by which market benchmarks may be inferred. Conventionally, these holes in the market benchmark data offered by 3^{rd} party vendors are patched by assuming the missing data is equal, or similar, to known portions of the data. While this provides enough information for market benchmarks to ultimately be determined, the benchmarks which are determined are typically inaccurate. Moreover, the extent of the inaccuracy is not known, thereby causing many conventional offers submitted in response to service requests to be significantly inaccurate, ultimately causing the service contract opportunity to be lost.

As a result, service providers have conventionally been unable to compose offers which accurately address a given service request, much less efficiently. However, in sharp contrast to these conventional shortcomings, various ones of the approaches included herein provide implementations which are able to systematically provide useful information from previously satisfied service requests, thereby significantly improving the efficiency and accuracy by which new service requests may be processed. Some of the approaches included herein are also able to compute similarity scores (e.g., confidence scores) which correspond to the drafted response to a service request, and standardize the similarity scores based on performance in similar situations. Moreover, approaches included herein are able to draft accurate responses to service requests, even in situations where corresponding information is lost and/or unavailable. As a result, the various approaches described and/or referred to herein are able to achieve scalability for offering relevant services which match received requests at an accuracy which is significantly higher than conventionally achievable, e.g., as will be described in further detail below.

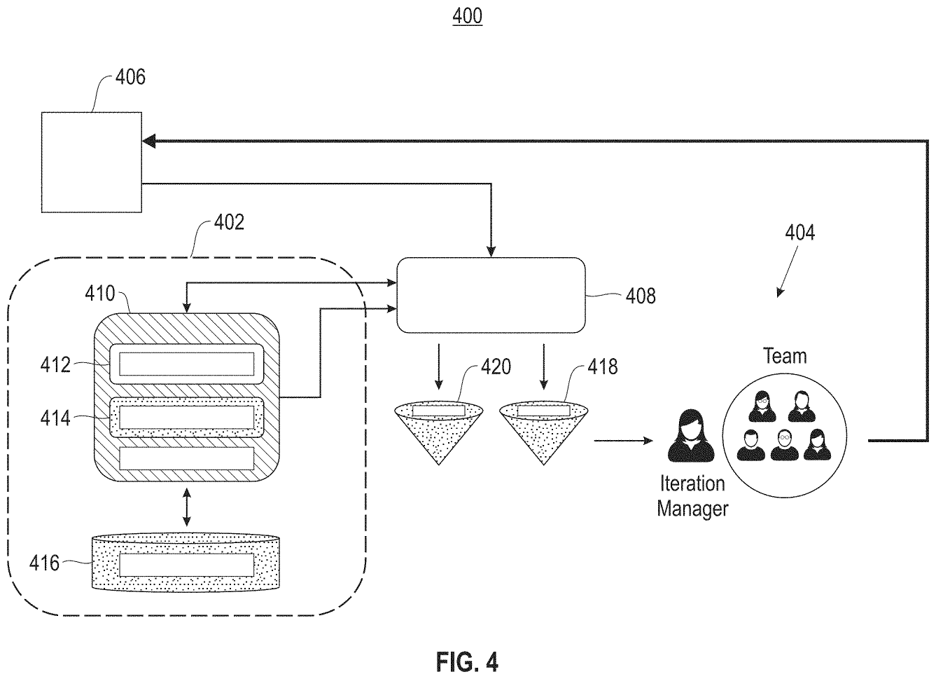

Looking now to FIG. 4, an overview of a system 400 which is able to train and implement a model capable of accurately and efficiently analyzing received service requests is illustrated in accordance with one approach. As an option, the present system 400 may be implemented in conjunction with features from any other approach listed herein, such as those described with reference to the other FIGS. However, such system 400 and others presented herein may be used in various applications and/or in permutations which may or may not be specifically described in the illustrative approaches listed herein. Further, the system 400 presented herein may be used in any desired environment. Thus FIG. 4 (and the other FIGS.) may be deemed to include any possible permutation.

As alluded to above, the system 400 includes a training and prediction segment 402 as well as an application segment 404, each of which may be used in combination with each other. Depending on the particular approach, the training and prediction segment 402 as well as the application segment 404 may be implemented in their own respective modules which are able to communicate with each other, in a same computing environment, at different geographical locations, etc. Accordingly, the components and/or process flows illustrated in FIG. 4 are in no way intended to be limiting.

The training and prediction segment 402 is utilized to develop a model that is capable of accurately and efficiently analyzing newly received (e.g., non-curated) service requests. This model may be trained using a number of known datasets, each dataset including information corresponding to a previously submitted service request, and a team that satisfied the respective previously submitted service request, e.g., as will soon become apparent. With respect to the present description, “known” is intended to signify that the relationship between the service requests and the teams that satisfied the service requests respectively, has already been determined. In some approaches, this may be achieved by implementing manual curation.

For instance, service requests are received from a potential customer 406. In some approaches, the service request is a request for proposal which is received from a potential customer. However, it should be noted that a request for proposal is in no way required in order for system 400 to be performed successfully and accurately. It should also be noted that any one or more of the processes depicted in system 400 may be performed by a processor located at and/or in communication with a service provider in some approaches. Similarly, any one or more of the components depicted in system 400 may be located at and/or be in communication with a service provider in some approaches. Accordingly, the various features associated with FIG. 4 have been described from the perspective of a service provider. It should be noted that this is in no way intended to be limiting, but rather has been presented by way of example only, and solely to place various approaches in a given context.

Service requests that are received from a potential customer 406 are directed to a routing rules engine 408 which is able to communicate with the training and prediction segment 402. In some approaches, the service requests received at the routing rules engine 408 may be stored in memory located at and/or which is accessible by the routing rules engine 408. Moreover, the routing rules engine 408 preferably provides at least a copy of the received service requests to the training and prediction segment 402, e.g., such that the requests may be used to train a model which is capable of accurately and efficiently processing newly received service requests.

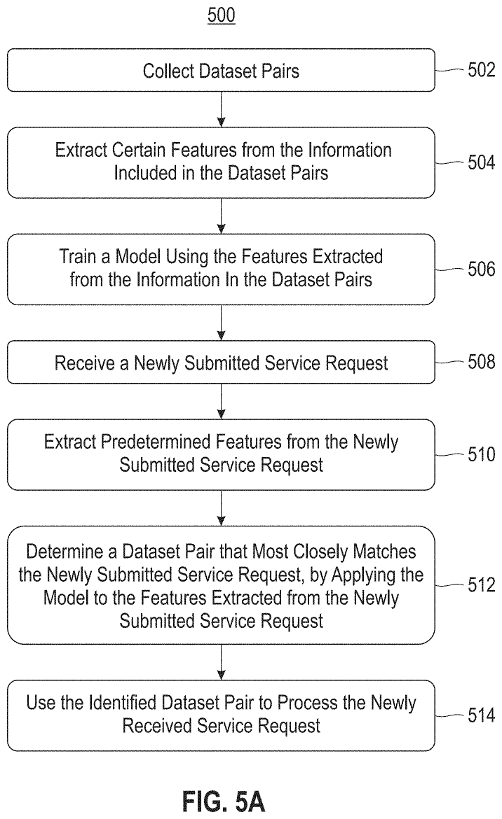

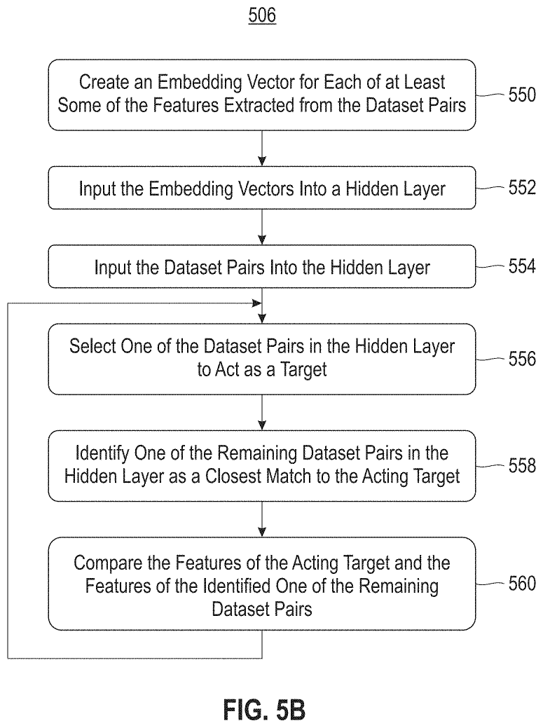

Looking to the training and prediction segment 402, at least a copy of a received service request is provided to a module 410, which includes a recommendation component 412 and a training component 414. Depending on the particular approach, the module 410 may be of any type which would be appreciated by one skilled in the art after reading the present description. For example, in some approaches the module 410 is a softmax module which is capable of implementing a softmax function. In other words, the module 410 may be able to convert a vector of “K” real values into a vector of “K” real values that sum to 1, e.g., as would be appreciated by one skilled in the art. It should also be noted that the module 410 and/or the components 412, 414 therein may include any desired number of processors which are capable of receiving, processing, issuing, etc., instructions. For example, the module 410 and/or the components 412, 414 therein may perform any one or more of the processes included in method 500 of FIGS. 5A-5B below.

With continued reference to FIG. 4, the module 410 is also able to communicate with a local memory 416. Thus, the module 410 is able to receive data from, send data to, issue instructions to, etc., the local memory 416. In preferred approaches, the local memory 416 is used to store datasets which correspond to the service requests that are received. Each dataset may include information which corresponds to a copy of a service request received at the training and prediction segment 402, as well as information regarding how the given service request was analyzed and satisfied by a team of various components and/or employees. For instance, one or more predetermined features associated with the service request as well as one or more predetermined features associated with the team that ultimately attempted to satisfy the service request may be extracted and stored. These features may be predetermined by an administrator, the entity that issued the service request, based on industry standards, etc.

As a result, the local memory 416 is able to accumulate a collection of the service requests that have been received over time, as well as details associated with how the service requests were analyzed and even performed by a team. According to an example which is in no way intended to limit the invention, the local memory 416 may store the service request types, any comments included with the service requests, corresponding market information, total contract value (TCV) associated with the service request(s), a country or region which the service requests correspond to, relevant sector information, etc. According to another example, which again is in no way intended to limit the invention, the local memory 416 may store geographic information corresponding to the teams that were used to satisfy the service requests, corresponding market information, a number of team members that were used to satisfy the service requests, etc. It follows that each dataset stored may include information which corresponds to a copy of a service request received at the training and prediction segment 402, as well as information regarding how the given service request was analyzed and satisfied by a team.

During the training phase, the datasets received by the training and prediction segment 402 are used to identify relationships between features associated with the service request and the same or similar features associated with the team used to satisfy the service request. In other words, the relationship that exists between these previously received and processed service requests, and the teams that satisfied them respectively, may be gleaned from the various datasets that have been stored in memory 416. Moreover, these relationships that are identified between certain features may further serve as a body of information which is used to teach the training and prediction segment 402 how to process various service requests. Thus, by evaluating this known information, the training and prediction segment 402 is able to develop a model over time that is able to efficiently evaluate new service requests and provide augmented information derived from similar previous requests, e.g., as will be described in more detail below (see FIGS. 5A-5B).

Referring still to FIG. 4, it follows that the training and prediction segment 402 may be able to output a previously satisfied service request that closely resembles a newly received service request. Again, the similarity between the previously satisfied service request and the newly received service request may be determined based on comparing predetermined features from each of the requests. For example, a similarity value which represents how similar two service requests are may be determined by calculating a cosine similarity, a dot product, etc., therebetween. The training and prediction segment 402 is also preferably able to output information that describes how a team was able to satisfy the previous service request. Again, the training and prediction segment 402 preferably stores datasets which preserve the relationship between a given previous service request and information (e.g., features) describing how the team satisfied the given previous service request. Thus, by identifying a previously satisfied service request, the training and prediction segment 402 is able to recommend a way of satisfying the service request that is known to produce favorable results.

This is desirable, particularly in view of the conventional shortcomings that have been experienced, because by comparing certain features included in a new service request with the same certain features in various previously satisfied service requests, some of the approaches herein are able to significantly reduce the computational processing involved with producing a response (e.g., offer) to the new service request. For instance, the sheer number of different possible combinations of features from various previously satisfied service requests that may happen to correspond to the features presented in a newly received service request also extends far beyond what is humanly capable. In other words, the countless different combinations of features that may be relevant to a given service request is otherwise unprocessable by the unaided human mind. Thus, the approaches herein provide significant improvements to those conventional implementations that rely on the expertise of their employees and the information they have retained from previously completed service deals. Further still, these approaches are able to significantly accelerate the processing of newly received service requests, while also maintaining a high level of accuracy in terms of how the service request is ultimately satisfied. Thus, various ones of the approaches herein are also able to achieve substantial improvements over conventional systems that rely on quote-to-cash implementations and similar types of management analysis, e.g., as would be appreciated by one skilled in the art after reading the present description.

The way of satisfying the service request that is recommended by the training and prediction segment 402 is provided to the routing rules engine 408. In other words, the routing rules engine 408 receives a dataset which includes a previously satisfied service request which most closely resembles the newly received service request, and which also includes relevant information about the team used to actually satisfy the previous service request. The routing rules engine 408 may then use this relevant team information (e.g., features) to determine whether a sufficiently similar team is available to satisfy the newly received service request. This determination may be made by comparing the features associated with the relevant team information with the features of any available team in a specialized repository 418. According to an example, which is in no way intended to limit the invention, if a team of 5 individuals located in Germany with experience in foreign markets were utilized to successfully and efficiently satisfy the previous service request that most closely matches a newly received service request, it is preferred that the same, or a similar, team is utilized to satisfy the newly received service request.

Upon identifying a team that a sufficiently similar team is available to satisfy the newly received service request, the newly received service request may be provided to the team and/or an iteration manager working with the team. Moreover, once the team has satisfied the service request, the resulting product and/or service is made available to the entity (e.g., person, company, government, etc.) that originally issued the service request. However, if it is determined that a sufficiently similar team is not available to satisfy the newly received service request, the routing rules engine 408 may resort to identifying a best matching team from a generic repository 420. Upon identifying a team from the generic repository 420, the newly received service request may be provided to the identified team and/or an iteration manager working with the team. Moreover, once the team has satisfied the service request, the resulting product and/or service is made available to the potential customer 406 (e.g., person, company, government, etc.) that originally issued the service request.

Again, various ones of the approaches included herein are able to significantly reduce the computational processing involved with producing a response (e.g., offer) to a new service request. Thus, the approaches herein provide significant improvements to those conventional implementations that rely on the expertise of their employees and the information they have retained from previously completed service deals. Further still, these approaches are able to significantly accelerate the processing of newly received service requests, while also maintaining a high level of accuracy in terms of how the service request is ultimately satisfied. Thus, various ones of the approaches herein are also able to achieve substantial improvements over conventional systems that rely on quote-to-cash implementations and similar types of management analysis, e.g., as would be appreciated by one skilled in the art after reading the present description.

Moving to FIG. 5A, a more detailed flowchart of a method 500 for training and implementing a model capable of accurately and efficiently analyzing received service requests, is shown according to one approach. The method 500 may be performed in accordance with the present invention in any of the environments depicted in FIGS. 1-4, among others, in various approaches. Of course, more or less operations than those specifically described in FIG. 5A may be included in method 500, as would be understood by one of skill in the art upon reading the present descriptions.

Each of the steps of the method 500 may be performed by any suitable component of the operating environment. For example, at least some of the processes included in method 500 may be performed by the training module 410 of FIG. 4 and/or the components 412, 414 that are included therein. In another example, any one or more of the processes included in method 500 may be performed by a central controller in FIG. 4 (not shown) that is capable of communicating with (e.g., sending instructions to, receiving information from, exchanging information with, etc.) any of the components illustrated in the system 400. In various other approaches, the method 500 may be partially or entirely performed by a controller, a processor, a computer, etc., or some other device having one or more processors therein. Thus, in some approaches, method 500 is a computer-implemented method. Moreover, the terms computer, processor and controller may be used interchangeably with regards to any of the approaches herein, such components being considered equivalents in the many various permutations of the present invention.

Moreover, for those approaches having a processor, the processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5A, operation 502 of method 500 includes collecting datasets, where each dataset preferably includes information corresponding to a previously submitted service request, and a team that satisfied the respective previously submitted service request. However, it should be noted that datasets may include any desired type of information and/or any desired number of types of information. For instance, one or more of the datasets collected in operation 502 may include information corresponding to an entity that issued the previously submitted service request, information corresponding to an efficiency by which the previously submitted service request was satisfied, etc. Moreover, in some approaches, the datasets may be collected during the normal course of operation as service requests are received and satisfied over time. In other approaches the datasets may be acquired from another system, purchased from a 3^{rd} party to supplement existing datasets, developed by running a model, etc. These datasets are also preferably stored in memory such that they may be accumulated and used as they become relevant.

Proceeding to operation 504, certain features are extracted from the information included in the datasets. In other words, specific data are gleaned from the datasets. The features that are extracted from the information included in the datasets may be predetermined in some approaches, e.g., by a potential customer, an administrator, etc. Moreover, it is preferred that features are extracted from the information corresponding to the service request as well as from the information corresponding to the team that satisfied the service request. As noted above, features which may be extracted from the information in the dataset which corresponds to the service request itself can include the service request type, any comments included with the service request, corresponding market information, TCV, a country or region which the service request corresponds to, relevant sector information, etc. Features which may be extracted from the information in the dataset which corresponds to the team that satisfied the given service request can include geographic information corresponding to the team, corresponding market information, a number of team members that were used to satisfy the service request, etc.

Operation 506 further includes training a model using the features extracted from the information in the datasets. As noted above, in some approaches the model that is trained is a softmax model which is capable of implementing a softmax function, e.g., as would be appreciated by one skilled in the art after reading the present description. However, any desired type of model may be implemented.

With respect to operation 506, FIG. 5B illustrates exemplary sub-processes of training a model using the features extracted from the information in the datasets in accordance with one approach. Accordingly, one or more of the sub-processes in FIG. 5B may be used to perform operation 506 of FIG. 5A. However, it should be noted that the sub-processes of FIG. 5B are illustrated in accordance with one approach which is in no way intended to limit the invention.

As shown, sub-operation 550 includes creating an embedding vector for each of at least some of the features extracted from the datasets. In other words, an embedding vector is preferably created for each of the different features such that the same feature from the service request and the team that satisfied the service request are used to create the same embedding vector. For instance, an embedding vector that represents the market information associated with the service request as well as the market information associated with the team that satisfied the service request may be created. However, in some approaches, an embedding vector may be created for the features of the service request and the team separately. According to an example, which is in no way intended to limit the invention, an embedding vector may be created for any one or more of the service request type, any comments included with the service request, market information corresponding to the service request, TCV, a country or region which the service request corresponds to, sector information relevant to the service request, etc. An embedding vector may similarly be created for any one or more of the geographic information corresponding to the team, market information which corresponds to the team, a number of team members that were used to satisfy the service request, etc. It should also be noted that any of the embedding vectors may be created using any processes that would be apparent to one skilled in the art after reading the present description.

After being created in sub-operation 550, the embedding vectors are input into a hidden layer. See sub-operation 552. The hidden layer may be formed in the model using any processes that would be apparent to one skilled in the art after reading the present description. Moreover, the embedding vectors may be stored in an embedding matrix that is located in the hidden layer. While the embedding matrix may serve as an efficient way of accessing the different embedding vectors, the embedding vectors may be stored in any desired format in the hidden layer, e.g., in a lookup table, using one or more bits, metadata, etc. In some approaches the embedding vectors may even be stored elsewhere and the hidden layer may simply be able to access the embedding vectors.

Moreover, sub-operation 554 includes inputting the datasets into the hidden layer. It follows that the hidden layer preferably includes vectors that correspond to the different features of various datasets, as well as the datasets themselves. Thus, the hidden layer also includes the information (e.g., features) which corresponds to the previous service requests and the teams that satisfied them. In other words, the hidden layer may ultimately contain all the information (e.g., embedding vectors and datasets) that is used to analyze and process newly received service requests. Moreover, the hidden layer is preferably formed in memory that is accessible by the model (e.g., see memory 416 in FIG. 4).

Although the hidden layer may include a number of datasets and embedding vectors, training is performed in order to develop the model that is capable of accurately and efficiently analyzing newly received (e.g., non-curated) service requests as mentioned above. During the training phase, the datasets and corresponding embedding vectors are used to identify relationships between features associated with the service request and the same or similar features associated with the team used to satisfy the service request. In other words, the relationship that exists between the embedding vectors of the previous service requests and the teams that satisfied them respectively, may be gleaned from the various datasets that have been stored. Moreover, these relationships that are identified between certain features further serve as a body of information which is used to teach the model how to process various service requests. Thus, by evaluating this known information, the model is formed over time such that it is able to efficiently evaluate new service requests and provide augmented information derived from similar previous requests.

Accordingly, from sub-operation 554, the flowchart proceeds to sub-operation 556 which includes selecting one of the datasets in the hidden layer to act as a target. The selected dataset acts as a target in the sense that the service request portion of the dataset is treated as if it were a newly received service request, while the information pertaining to the team that ultimately satisfied the service request acting as the target is ignored for the time being. Moreover, the remainder of the datasets in the hidden layer are examined in an effort to identify another previous service request which most closely matches the target service request. In preferred approaches, at least the first dataset selected is done so at random, while subsequent datasets may be selected in a predetermined order. However, in other approaches all datasets may be selected at random during the training phase.

As noted above, the similarity between two given service requests may be determined by comparing one or more predetermined features associated with each of the service requests. For example, the service request types, any comments included with the service requests, corresponding market information, TCV, a country or region which the service requests correspond to, relevant sector information, etc. may be compared to determine a similarity between two given service requests. Thus, by comparing one or more predetermined features of the target service request with corresponding features of the remaining service requests in the hidden layer, a service request which most closely matches the target service request may be identified. More specifically, in some approaches two service requests may be compared and the similarity therebetween may be computed by calculating a cosine similarity, a dot product, etc. of the two service requests.

Accordingly, sub-operation 558 includes identifying one of the remaining datasets in the hidden layer as a closest match to the acting target, while sub-operation 560 includes comparing the features of the acting target and the features of the identified one of the remaining datasets. In some approaches, the service request determined as having a highest similarity score with the target service request may be identified as the closest match to the acting target. However, in some approaches a threshold similarity score may be implemented, e.g., to determine whether the model was able to select a dataset that was a sufficiently close match to the acting target. In other words, two service requests are not deemed as being a closest match unless the similarity score(s) therebetween exceed a predetermined threshold. This is particularly apparent while training the model, as the closer the match between the service requests, the more accurately the model is able to process newly received service requests. In such approaches, if no service request is deemed to be a close enough match to the target service request, an error may be produced, the target service request may be flagged for further inspection, additional training for the model may be initiated, more datasets may be introduced to the hidden layer, etc.

From sub-operation 560, the flowchart returns to sub-operation 556 such that a subsequent one of the datasets in the hidden layer can be selected to act as a target. It follows that each of the datasets in the hidden layer are preferably selected as the target over time, thereby thoroughly testing the model. While the flowchart illustrated in FIG. 5B may continue repeating until all datasets in the hidden layer are tested as an acting target, in other approaches a majority of the datasets in the hidden layer may be tested. In still other approaches, the flowchart of FIG. 5B may repeat continuously such that the model and the datasets in the hidden layer are constantly being tested. Yet in other approaches, the flowchart of FIG. 5B may continue repeating until all datasets in the hidden layer are tested as an acting target, until new datasets are introduced to the hidden layer, whereby the flowchart of FIG. 5B may be reinitiated in order to test each of the newly introduced datasets in the hidden layer. It follows that the various sub-operations in FIG. 5B may be repeated any number of times, e.g., as additional embedding vectors are created and more datasets are received. This allows for the model to constantly be improved which continues to improve performance of the system as a whole by reducing computational overhead, reducing search times, increasing accuracy, improving efficiency by which new service requests may be processed by the system, etc.

Returning now to FIG. 5A, method 500 proceeds from operation 506 to operation 508 which includes receiving a newly submitted service request. As noted above, a service request may be submitted by any type of entity, e.g., person, company, group, government, etc. Moreover, the new offer request includes information (e.g., metadata) in some approaches which corresponds to the potential customer themselves and/or the services they are seeking. For instance, in different approaches the offer request may include geography-based information, market-based information, or any other type of geographic-based information. In some approaches the offer request even includes requests for more than one offers. A service provider which receives the offer request may use the information included in the request to filter available offerings and/or the services included therein. For instance, in some approaches meta information pertaining to geography, date, industry, etc. of the offer request is used to filter the available offerings and services that have the matching values for the respective fields (e.g., criteria). Each of these fields serves as a characteristic of the overarching offering, thereby providing the scope of the services in each of the services.

It should also be noted that while it is preferred that the model is fully trained before a new service request is received, depending on the situation, a service request may be received at any time. Thus, while method 500 illustrates operations 502, 504, 506 as being performed prior to receiving a newly submitted service request in operation 508, it should be noted that this is in no way intended to limit the invention. Rather, in some approaches the model may constantly be training in the background, while newly received services requests are processed in the foreground. In other approaches, the process of training the model may temporarily pause while a newly received service request is being processed. In still other approaches, the model may continue to be trained whenever a newly received service request is not being processed thereby.

Moving to operation 510, here method 500 includes extracting predetermined features from the newly submitted service request. As noted above, certain features are extracted from the information included in the datasets. In other words, specific data are gleaned from the datasets. The features that are extracted from the information included in the datasets may be predetermined in some approaches, e.g., by a potential customer, an administrator, etc. Moreover, it is preferred that features are extracted from the information corresponding to the service request as well as from the information corresponding to the team that satisfied the service request. Features which may be extracted from the information in the dataset which corresponds to the service request itself can include the service request type, any comments included with the service request, corresponding market information, TCV, a country or region which the service request corresponds to, relevant sector information, etc. Moreover, features which may be extracted from the information in the dataset which corresponds to the team that satisfied the given service request can include geographic information corresponding to the team, corresponding market information, a number of team members that were used to satisfy the service request, etc.

Moreover, operation 512 includes determining a dataset that most closely matches the newly submitted service request, by applying the model to the features extracted from the newly submitted service request. It follows that performing operation 512 may include any one or more of the approaches described above with respect to sub-operations 558, 560 of FIG. 5B. For instance, determining a dataset that most closely matches a newly submitted service request, by applying the model to the features extracted from the newly submitted service request may be performed by calculating a similarity score between the newly submitted service request and each of the datasets in the hidden layer. Thus, by comparing predetermined features associated with the newly submitted service request with comparable predetermined features associated with the service request included in each of the datasets in the hidden layer, operation 512 may be able to determine the dataset that most closely matches the newly received service request. In other words, each feature extracted from the new service request is used to generate its own vector, each of which are then compared against the vectors stored in the embedding matrix.

In some approaches, the dataset determined as having a highest similarity score with (e.g., determined as being the closest match to) the newly received service request may be identified in operation 512 in some approaches. However, in other approaches a predetermined threshold may be used to quantify whether the dataset determined as having a highest similarity score with the newly received service request should actually be used to process the newly received service request.

Moreover, the similarity between the new service request and the service request included in a given dataset may be determined by computing a cosine similarity value between the newly submitted service request and the service request included in a given one of the datasets. In other approaches, the similarity between the new service request and the service request included in a given dataset may be determined by computing a dot product value between the newly submitted service request and the service request included in a given one of the datasets.

In response to identifying one of the datasets as most closely matching the newly submitted service request, method 500 proceeds to operation 514, whereby the identified dataset is used to process the newly received service request. By determining that the service request portion of the identified dataset closely matches the newly submitted service request, the corresponding team information in the identified dataset is known to be a desirable method of satisfying the new service request. In other words, by determining that a previously satisfied service request is sufficiently similar to a newly received service request (e.g., the two requests have sufficiently high similarity scores), it can also be determined that if the same team settings are applied to the new service request as were applied to the previously satisfied service request, the newly received service request will desirably be satisfied efficiently, accurately, and in a predictable manner.

It follows that by performing various ones of the processes included in method 500, some of the approaches herein are able to significantly reduce the computational processing involved with producing a response (e.g., offer) to a newly received service request. For instance, the sheer number of different possible combinations of features from various previously satisfied service requests that may happen to correspond to the features presented in a newly received service request extends far beyond what is humanly capable. In other words, the countless different combinations of features that may be relevant to a given service request is otherwise unprocessable by the unaided human mind. Thus, the approaches herein provide significant improvements to those conventional implementations that rely on the expertise of their employees and the information they have retained from previously completed service deals. Further still, these approaches are able to significantly accelerate the processing of newly received service requests, while also maintaining a high level of accuracy in terms of how the service request is ultimately satisfied. Moreover, by training and implementing a model that can constantly be improved, performance of the system as a whole continues to be improved as well by reducing computational overhead, reducing search times, increasing accuracy, improving efficiency by which new service requests may be processed by the system, etc. Thus, various ones of the approaches herein are able to achieve substantial improvements over conventional systems that rely on quote-to-cash implementations and similar types of management analysis, e.g., as would be appreciated by one skilled in the art after reading the present description.

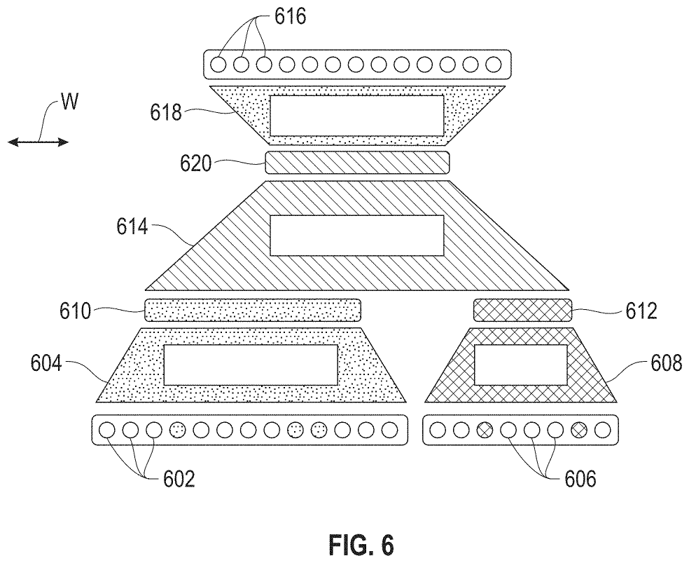

Referring now to FIG. 6, an illustrative view of a softmax model 600 which is able to accurately and efficiently analyze newly received service requests is presented in accordance with one approach. As an option, the present softmax model 600 may be implemented in conjunction with features from any other approach listed herein, such as those described with reference to the other FIGS. However, such softmax model 600 and others presented herein may be used in various applications and/or in permutations which may or may not be specifically described in the illustrative approaches listed herein. Further, the softmax model 600 presented herein may be used in any desired environment. Thus FIG. 6 (and the other FIGS.) may be deemed to include any possible permutation.

As shown, a number of features 602 associated with previously processed service requests are used to form a number of embedding vectors 604 that correspond to the service request itself. Similarly, a number of features 606 associated with the teams that were utilized to satisfy previously processed service requests are used to form a number of embedding vectors 608 that correspond to the team.

While the number of embedding vectors 604 that correspond to the service request itself are created, only a select subset of the embedding vectors 604 are actually used to identify (e.g., represent) a given service request. Moreover, each of the select subsets of the embedding vectors 604 are input into the hidden layer 614. This is represented by block 610 which is narrower in the width direction W than the number of initial features 602 that were input as a representation for a given service request. Similarly, only a select subset of the embedding vectors 608 are actually used to identify (e.g., represent) a given team that satisfied a given service request. Moreover, each of the select subsets of the embedding vectors 608 are input into the hidden layer 614. This is represented by block 612 which is narrower in the width direction W than the number of initial features 606 that were input as a representation for a given team that satisfied a given service request. It should also be noted that each select subset of the embedding vectors 608 and each select subset of the embedding vectors 604 may be input in the hidden layer 614 as a dataset. Thus, if a newly received service request were to match with a select subset of the embedding vectors 604, the corresponding select subset of the embedding vectors 608 may be used to determine how the given service request should be satisfied (e.g., the team used), e.g., as described in some of the approaches above.

Once in the hidden layer 614, the datasets may be used for training the model as a whole, e.g., according to any of the approaches described herein. For example, any one or more of the sub-operations included in FIG. 5B may be performed by and/or in the hidden layer 614. The hidden layer 614 may also be used to process newly received service requests.

For instance, the features 616 associated with a newly received service request are extracted from the service request and used to form embedding vectors 618 that correspond to the service request itself. In some approaches, when a new service request is received, service request embedding vectors may be aggregated from the previously satisfied service requests under the same category, based on the feature of service request. The aggregation may be performed by calculating an average, a concentration, etc., depending on the desired approach. Moreover, examples of features of service request include service request type, service request comments, corresponding market, country of implementation, corresponding sector, TCV, etc. Given the aggregated embedding, the most similar previously performed service requests can be identified and used as a reference to complete the newly received service request. In some approaches, the similarity between service requests is computed by the similarity of embeddings, e.g., such as cosine similarity, dot product, etc.

As a result, the embedding vectors 618 associated with the newly received service request may be compared against the embedding vectors in the hidden layer 614 that are formed from features associated with the previously processed service requests. Moreover, upon identifying a closest matching select subset of the embedding vectors 604 (e.g., see box 620), the corresponding select subset of the embedding vectors 608 may be used to determine how the new service request should be satisfied (e.g., the team used), e.g., as described in some of the approaches above. It follows that the hidden layer 614 may be able to produce a previously satisfied service request that is a same dimension (e.g., includes a same number of predetermined features) as the newly received service request. Embedding vectors associated with the service requests may thereby be reused to represent the target service request.

Once again, various ones of the approaches herein are able to significantly reduce the computational processing involved with producing a response (e.g., offer) to a newly received service request. For instance, the approaches herein provide significant improvements to those conventional implementations that rely on the expertise of their employees and the information they have retained from previously completed service deals. Further still, these approaches are able to significantly accelerate the processing of newly received service requests, while also maintaining a high level of accuracy in terms of how the service request is ultimately satisfied. Moreover, by training and implementing a model that can constantly be improved, performance of the system as a whole continues to be improved as well by reducing computational overhead, reducing search times, increasing accuracy, improving efficiency by which new service requests may be processed by the system, etc. Thus, various ones of the approaches herein are able to achieve substantial improvements over conventional systems that rely on quote-to-cash implementations and similar types of management analysis, e.g., as would be appreciated by one skilled in the art after reading the present description.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for reducing the computational overhead involved with processing received service requests, comprising:
collecting datasets, each dataset including: a previously submitted service request, and a team that satisfied the respective previously submitted service request;
extracting features from the datasets;
training a model using the features extracted from the datasets;
receiving a newly submitted service request;
extracting features from the newly submitted service request; and
determining a dataset that most closely matches the newly submitted service request, by applying the model to the features extracted from the newly submitted service request.

2. The computer-implemented method of claim 1, wherein training the model using the features extracted from the datasets includes:
creating an embedding vector for each of at least some of the features extracted from the datasets;
inputting the embedding vectors into a hidden layer;
inputting the datasets into the hidden layer; and
performing an iterative process which includes:
selecting one of the datasets in the hidden layer to act as a target,
identifying one of the remaining datasets in the hidden layer as a closest match to the acting target, and
comparing the features of the acting target and the features of the identified one of the remaining datasets.

3. The computer-implemented method of claim 2, wherein the embedding vectors are stored in an embedding matrix, wherein the model is a softmax model.

4. The computer-implemented method of claim 1, wherein extracting features from the datasets includes:
extracting features from the previously submitted service request; and
extracting features from the team that satisfied the respective previously submitted service request,
wherein the features extracted from the previously submitted service request are selected from the group consisting of: service request type, service request comments, corresponding market information, and TCV,
wherein the features extracted from the team that satisfied the respective previously submitted service request are selected from the group consisting of: geographic information, corresponding market information, and team size.

5. The computer-implemented method of claim 1, wherein determining the dataset that most closely matches the newly submitted service request, by applying the model to the features extracted from the newly submitted service request includes:
calculating a similarity score between the newly submitted service request and each of the datasets; and
selecting the dataset that produced the highest similarity score as the dataset that most closely matches the newly submitted service request.

6. The computer-implemented method of claim 5, wherein calculating the similarity score between the newly submitted service request and a given one of the datasets includes: computing a cosine similarity value between the newly submitted service request and the given one of the datasets.

7. The computer-implemented method of claim 5, wherein calculating the similarity score between the newly submitted service request and a given one of the datasets includes: computing a dot product between the newly submitted service request and the given one of the datasets.

8. The computer-implemented method of claim 1, wherein determining a dataset that most closely matches the newly submitted service request by applying the model to the features extracted from the newly submitted service request reduces computational overhead of the computer.

9. A computer program product for reducing the computational overhead involved with processing received service requests, the computer program product comprising a computer readable storage medium having program instructions embodied therewith, the program instructions readable and/or executable by a processor to cause the processor to:
collect, by the processor, datasets, each dataset including: a previously submitted service request, and a team that satisfied the respective previously submitted service request;
extract, by the processor, features from the datasets;
train, by the processor, a model using the features extracted from the datasets;
receive, by the processor, a newly submitted service request;
extract, by the processor, features from the newly submitted service request; and
determine, by the processor, a dataset that most closely matches the newly submitted service request, by applying the model to the features extracted from the newly submitted service request.

10. The computer program product of claim 9, wherein training the model using the features extracted from the datasets includes:
creating an embedding vector for each of at least some of the features extracted from the datasets;
inputting the embedding vectors into a hidden layer;
inputting the datasets into the hidden layer; and
performing an iterative process which includes:
selecting one of the datasets in the hidden layer to act as a target,
identifying one of the remaining datasets in the hidden layer as a closest match to the acting target, and
comparing the features of the acting target and the features of the identified one of the remaining datasets.

11. The computer program product of claim 10, wherein the embedding vectors are stored in an embedding matrix, wherein the model is a softmax model.

12. The computer program product of claim 9, wherein extracting features from the datasets includes:
extracting features from the previously submitted service request; and
extracting features from the team that satisfied the respective previously submitted service request,
wherein the features extracted from the previously submitted service request are selected from the group consisting of: service request type, service request comments, corresponding market information, and TCV,
wherein the features extracted from the team that satisfied the respective previously submitted service request are selected from the group consisting of: geographic information, corresponding market information, and team size.

13. The computer program product of claim 9, wherein determining the dataset that most closely matches the newly submitted service request, by applying the model to the features extracted from the newly submitted service request includes:
calculating a similarity score between the newly submitted service request and each of the datasets; and
selecting the dataset that produced the highest similarity score as the dataset that most closely matches the newly submitted service request.

14. The computer program product of claim 13, wherein calculating the similarity score between the newly submitted service request and a given one of the datasets includes: computing a cosine similarity value between the newly submitted service request and the given one of the datasets.

15. The computer program product of claim 13, wherein calculating the similarity score between the newly submitted service request and a given one of the datasets includes: computing a dot product between the newly submitted service request and the given one of the datasets.

16. The computer program product of claim 9, wherein determining a dataset that most closely matches the newly submitted service request by applying the model to the features extracted from the newly submitted service request reduces computational overhead of the processor.

17. A system, comprising:
a processor; and
logic integrated with the processor, executable by the processor, or integrated with and executable by the processor, the logic being configured to:
collect, by the processor, datasets, each dataset including: a previously submitted service request, and a team that satisfied the respective previously submitted service request;
extract, by the processor, features from the datasets;
train, by the processor, a model using the features extracted from the datasets;
receive, by the processor, a newly submitted service request;
extract, by the processor, features from the newly submitted service request; and
determine, by the processor, a dataset that most closely matches the newly submitted service request, by applying the model to the features extracted from the newly submitted service request.

18. The system of claim 17, wherein training the model using the features extracted from the datasets includes:
creating an embedding vector for each of at least some of the features extracted from the datasets;
inputting the embedding vectors into a hidden layer;
inputting the datasets into the hidden layer; and
performing an iterative process which includes:
selecting one of the datasets in the hidden layer to act as a target,
identifying one of the remaining datasets in the hidden layer as a closest match to the acting target, and
comparing the features of the acting target and the features of the identified one of the remaining datasets,
wherein the model is a softmax model.

19. The system of claim 17, wherein extracting features from the datasets includes:
extracting features from the previously submitted service request; and
extracting features from the team that satisfied the respective previously submitted service request,
wherein the features extracted from the previously submitted service request are selected from the group consisting of: service request type, service request comments, corresponding market information, and TCV,
wherein the features extracted from the team that satisfied the respective previously submitted service request are selected from the group consisting of: geographic information, corresponding market information, and team size.

20. The system of claim 17, wherein determining the dataset that most closely matches the newly submitted service request, by applying the model to the features extracted from the newly submitted service request includes:
calculating a similarity score between the newly submitted service request and each of the datasets; and
selecting the dataset that produced the highest similarity score as the dataset that most closely matches the newly submitted service request.
